(19) United States
(12) Patent Application Publication
(10) Pub. No.: US 2012/0319372 A1
(43) Pub. Date: Dec. 20, 2012

(54) Compact Outboard Motor Cart

(76) Inventor: Bastian Sarh, Huntington Beach, CA (US)

(21) Appl. No.: 13/164,719

(22) Filed: Jun. 20, 2011

(51) Int. Cl. B62B 3/02

(52) U.S. Cl. 280/63

(57) ABSTRACT

The invention is an outboard motor cart that attaches to the skeg of lower unit of outboard motor common to marine vessels. Said outboard motor cart is small and compact in nature. Said cart is characterized by an adjustable clamp that attaches to skeg of lower unit of outboard motor, such that roll, yaw, fore and aft, and lateral forces are transferred between cart and motor. Motor weight is supported by a horizontal bracket of cart. Said cart is comprised of wheel or wheels that are positioned in a fore and aft manner, such that lateral roll of cart is possible. Motor balance and stability are controlled by handler during transport while cart is attached to motor.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention relates to a device for moving marine outboard motors across surfaces. The common type of marine outboard motor has a supporting bracket for removable mounting to the transom of a boat. It is common practice to dismount the outboard motor from the boat for storage, or to perform maintenance, or for transport. Often this requires moving the motor over land, docks, or other surfaces.

Outboard motors are difficult to carry or transport due to their weight and shape. State of the art outboard motor dollies consist of wheels attached to a tubular frame comprising a false transom plate to which the outboard motor supporting bracket attaches (e.g. U.S. Pat. Nos. D301,654 and D335,744). These dollies are large and bulky and are not compact or lightweight. Previous designs also include smaller devices that mount onto or around the lower unit (e.g. U.S. Pat. Nos. 2,811,942 and 2,822,183 and 4,044,978 and 4,570,960). Some such prior designs attach to the stem of the motor and enable enough support to stabilize the motor. By attempting to create a stable supporting structure, however, the outboard motor carrier again becomes bulky and heavy.

A simple and compact device for wheeling the outboard motor over surfaces is proposed which greatly facilitates the task of transporting a motor. Prior to the present invention no simple and compact device for performing this function has been developed.

### BRIEF SUMMARY OF THE INVENTION

The present outboard motor cart is characterized by attaching to the lower unit of an outboard motor by clamping onto the skeg of lower unit below the gear housing. The present cart comprises a horizontal support bracket upon which the weight of the outboard motor rests. Wheels are attached to said horizontal support bracket via wheel axles and in the preferred embodiment said wheels are positioned in a fore and aft configuration. An adjustable clamp attaches to the vertical skeg on lower unit of motor such that lateral roll, yaw, fore and aft, and lateral forces are transferred between cart and motor. The adjustable clamp also prevents the lower unit and motor from being removed from said cart by upward vertical motion when said clamp is tightened.

The present device enables the user to control the transport of motor by manually balancing and pushing the motor when placed onto cart. By wheel configuration being fore and aft, as opposed to side by side, lateral roll of the motor and cart occur together and are controlled by the handler. By cart and motor rotating together large righting moments from cart are not generated on the motor that could damage the lower unit, in contrast to previous designs that attempt to stabilize motor. This embodiment also enables directional control by user tilting the engine sideways during transport which creates yawing moments that change cart direction.

The outboard motor is lifted into cart, wherein the vertical skeg of the lower unit is inserted into the adjustable clamp of cart until the motor rests on the horizontal support bracket. The adjustable clamp may or may not be tightened in order to attach the cart to lower unit. The clamping mechanism generates a clamping force on skeg of lower unit because the cart itself is unstable when upright, and by holding the motor upright the clamp locks onto skeg as cart attempts to roll laterally. By balancing the motor in an upright manner, the user can then push the motor along a surface. The motor can be leaned up against a rigid structure during storage or lifted out of cart. The cart can be kept on the motor while in storage without significantly increasing the overall storage space required. The cart can be kept onboard boat when not in use due to its compact and lightweight nature. Such a cart has generic overall dimensions, for example, of length×width×height equal to 8 inches×4 inches×4 inches.

### BRIEF DESCRIPTION OF THE SEVERAL VIEWS OF THE DRAWING

FIG. 1 is a side view of present cart attached to the lower unit of the outboard motor standing in an upright position. Referring to this figure, pitch corresponds to rotating the outboard motor from its upright position. Translating the image left or right corresponds to fore and aft motion.

FIG. 2 is a perspective view showing the present cart.

FIG. 3 is a perspective view showing the present cart.

FIG. 4 is a front view of the present cart with the lower unit vertical skeg inside of the adjustable clamp and resting on the horizontal support bracket of the cart. Referring to this figure, lateral roll corresponds to rotating the lower unit from its vertical orientation. Translating the image left or right corresponds to lateral movement.

FIG. 5 is a top view of the present cart. Referring to this figure, yaw corresponds to rotating the cart from its horizontal position. Translating the image left or right corresponds to fore and aft motion. Translating the image up or down corresponds to lateral movement.

FIG. 6 is a perspective view of alternative embodiment of present cart.

FIG. 7 is a perspective view of alternative embodiment of present cart.

FIG. 8 is a front view of alternative embodiment of present cart.

### DETAILED DESCRIPTION OF THE INVENTION

As seen in FIG. 1, conventional outboard motor 1 has supporting bracket 2 for attachment to a boat. Lower unit 3 is comprised of gear housing 4 that transmits power to propeller 5.

Referring to FIGS. 1 and 4 conventional outboard motor 1 has lower unit 3 comprised of vertical skeg 6 below gear housing 4. In FIG. 1, outboard motor cart 7 is attached to lower unit 3 of outboard motor 1 by clamping to vertical skeg 6.

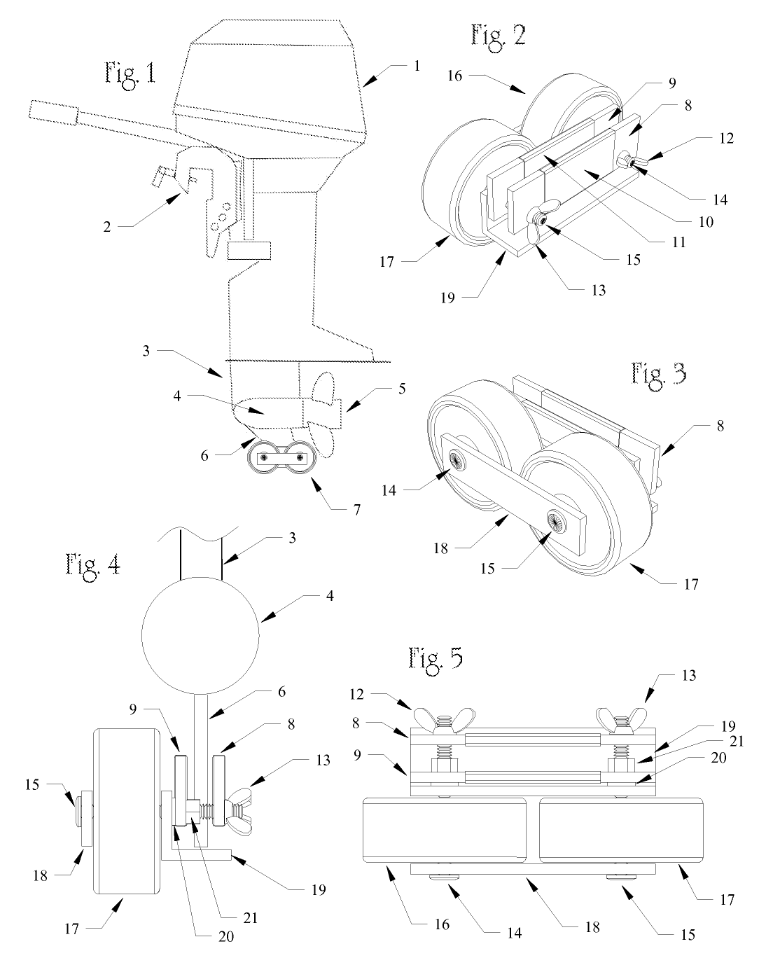

As seen in FIGS. 2 and 3 and 5, clamping mechanism is comprised of clamp outside 8 and clamp inside 9. Rubber cover 10 and rubber cover 11 are on clamp 8 and clamp 9, respectively. Hand nut 12 and hand nut 13 are on screw 14 and screw 15, respectively. Screw 14 and screw 15 are axles for wheel 16 and wheel 17, respectively. Screw 14 and screw 15 are attached to bracket 18.

As seen in FIG. 4, vertical skeg 6 of lower unit 3 rests inside of adjustable clamp of cart, comprised of clamp outside 8 and clamp inside 9. Lower unit 3 of outboard motor rests on horizontal support bracket 19. Spacing washer 20 is between clamp inside 9 and horizontal support bracket 19. Nut 21 is on screw 15 and attaches clamp inside 9 to horizontal support bracket 19. In this embodiment, clamp outside 8 can be tightened onto vertical skeg 6 by utilizing hand screw 12 and hand screw 13.

Referring to FIG. 4, lateral roll moments are transferred between said cart and lower unit vertical skeg 6 through the adjustable clamp, such that cart and motor rotate together. Furthermore, fore and aft forces, lateral forces, and yaw moments are transferred between said cart and lower unit vertical skeg 6 during transport for directional control.

In the preferred embodiment the wheels are placed fore and aft and the adjustable clamp and horizontal support bracket located vertically offset from said wheels. Placing the motor on cart thereby generates a moment on cart because weight of motor and wheels are not in vertical alignment. Said moment is counteracted by forces generated on the motor lower unit vertical skeg 6 by said cart adjustable clamp.

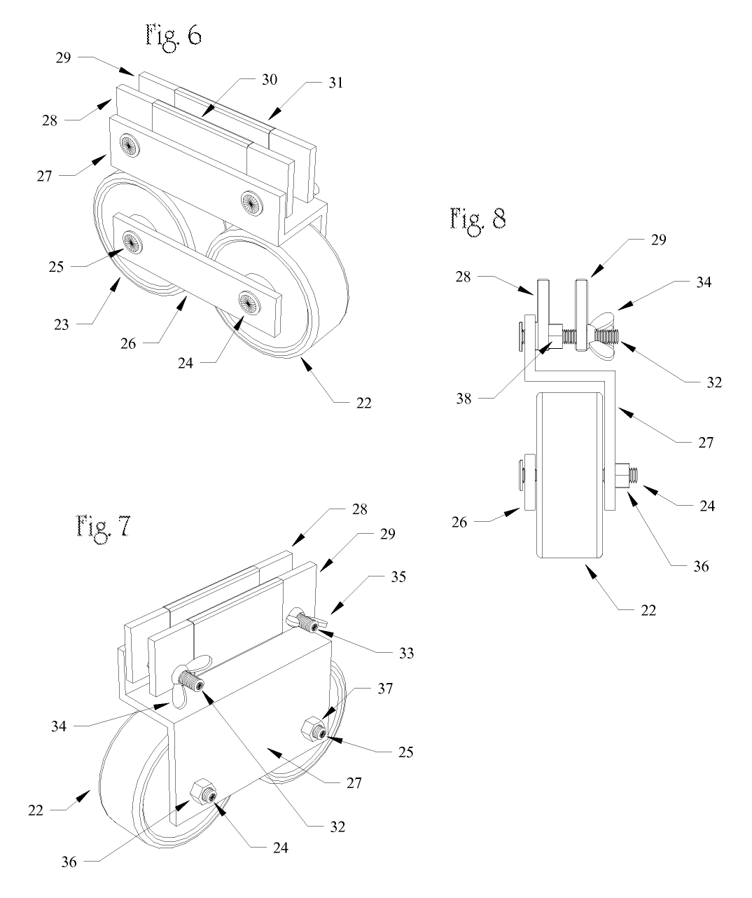

FIGS. 6 and 7 and 8 are one alternative embodiment of present cart. In this embodiment adjustable clamp comprised of members 28 and 29 is in vertical alignment with wheels 22 and 23. Screws 24 and 25 are axles for wheels 22 and 23, respectively, and are attached to bracket 26. Support bracket 27 is attached to screws 24 and 25 with nuts 36 and 37, respectively.

Referring to FIGS. 6 and 7 and 8, clamp member 28 and 29 are connected to support bracket 27 by screws 32 and 33. Nut 38 attaches clamp member 28 to support bracket 27. Adjustable screws 34 and 35 are used to adjust position of clamp member 29 on screws 32 and 33. Rubber covers 30 and 31 reside on clamp member 28 and 29, respectively.

Alternative embodiments include a clamp that is fixed in width, not adjustable in width. Alternative embodiments also include straightforward variations that utilize multiple components of said cart and forgoing components of said cart. It is further understood that simple variations or alterations of the invention made by one skilled in the art are covered by the appended claims.

1) I claim an outboard motor cart characterized by attaching cart to skeg of lower unit of outboard motor:

2) As stated in claim 1, said cart comprised of horizontal support bracket that supports motor weight, said horizontal support bracket attached offset to wheel.

3) As stated in claim 1 and claim 2, said cart comprised of horizontal support bracket attached offset to fore and aft positioned wheels.

4) As stated in claim 2 and claim 3, said cart comprised of horizontal support bracket that is horizontally displaced from said wheels.

5) As stated in claim 1, said cart is attached to skeg of lower unit of outboard motor by adjustable or non-adjustable clamp.

6) As stated in claim 5, said adjustable clamp can be tightened on skeg of outboard motor by mechanical means, e.g. screws and nuts.

7) As stated in claim 1, said cart comprised of horizontal support bracket that supports motor weight, said horizontal support bracket attached inline to wheel.

8) As stated in claim 1 and claim 7, said cart comprised of horizontal support bracket attached inline to fore and aft positioned wheels.
